(19) United States
(12) Patent Application Publication
(10) Pub. No.: US 2006/0053160 A1
(43) Pub. Date: Mar. 9, 2006

(54) IMPROVED MEANS FOR WEB ACCESS

(75) Inventors: JOHN-PAUL MATTIA, Alexandria, VA (US); Laura Adams, Alexandria, VA (US)

Correspondence Address: JUNEAU PARTNERS, P.O. BOX 2516, ALEXANDRIA, VA, 22301, US

(73) Assignee: CENTAUR STORAGE, Alexandria, VA (US)

(21) Appl. No.: 11/161,576

(22) Filed: Aug. 8, 2005

Related U.S. Application Data
(60) Provisional application No. 60/600,458, filed on Aug. 11, 2004.

(51) Int. Cl. G06F 17/00

(52) U.S. Cl. 707/103 X

(57) ABSTRACT

The present invention relates generally to data processing, and more specifically to a web identifier that embeds an instruction set for navigating through one or more World-Wide-Web (WWW) pages, and a specialized web browser for processing the web identifier.

### BACKGROUND OF THE INVENTION

1. Field of the Invention

The present invention relates generally to data processing. The invention relates more specifically to a web identifier that embeds an instruction set for navigating through one or more World-Wide-Web (WWW) pages, and a specialized web browser for processing the web identifier.

2. Description of Related Art

Internet web browser programs, such as Navigator.RTM. from Netscape Communications, Inc. or the Internet Explorer.RTM. from Microsoft, Inc., allow users to access information contained in web pages on the WWW. Some web pages are stored on a server system, and other pages are generated dynamically, for example by examining user input and then generating pages based on that user input. Web pages are typically delivered to a client in hyper-text markup language (HTML), and are identified by Uniform Resource Locators (URLs).

Oftentimes, a user must navigate through many intermediate web pages, entering multiple URLs or additional user-input information in order to obtain the web page containing the final information that is desired by the user. For example, when accessing a password-protected shared-memory space on a remote server, a user will have to enter username and password information, as well as navigate through several intermediate directories in order to access a particular file. In such a case, significant user interaction is required to access the desired information, and much of this interaction is repetitive or differs only slightly in subsequent access operations. In addition, many web pages are generated dynamically with tokens that prevent the user from book marking or caching the page contents for later use. This situation is time consuming and may be frustrating to the user, especially if the final web page is accessed frequently.

Therefore, an improved method of navigating and processing web page information is desirable to overcome the deficiencies and limitations of the prior art. The inventive subject matter claimed herein addresses some or all of the problems listed above.

### SUMMARY OF THE INVENTION

The inventive subject matter comprises, in one aspect, a method of sending, retrieving, or navigating through information on a remote or local computer, or on the Internet, or on an intranet.

The invention provides a method, system, and computer implementation to cause a computing device to handle, including but not limited to retrieve, send, navigate, information of multiple web pages by means of inserting a set of instructions at the client; processing the series of instructions using a specialized processor, where the processor evaluates the information retrieved in order to decide which instruction to execute next, with no user intervention; and where such information may be local, may be on the web, or may be a combination of local and web information.

### BRIEF DESCRIPTION OF THE DRAWINGS

FIG. 1 is a block diagram of a networked computer system. The invention described herein automatically handles information, possibly from multiple web pages, in order to retrieve information desired by the user.

FIG. 2 is a flow diagram of the process to retrieve a remote web page using the invention described herein.

FIG. 3 is a block diagram of a server-client system. Both the server and the client are equipped with the invention described herein.

### DETAILED DESCRIPTION OF THE INVENTION

The invention is now described on the basis of the preferred embodiments, which are not intended to limit the scope of the present invention, but serve to exemplify it. All of the features and combinations thereof described in the embodiment are not necessarily essential to the invention, and well-known features may be simplified or omitted from the text below, in order not to obscure the description of the present invention.

For the descriptions below, we utilize the term ARROW to mean a web identifier that allows the user to perform a variety of tasks. It may be represented as a textual string, or a set of binary bits. In the preferred embodiment, it contain one or more instructions and supporting data for performing a variety of tasks; such as, but not limited to, web searches, remote server access, file manipulation, file composition, or file deletion.

We also utilize the term ARROW PROCESSOR to mean a specialized browser. When the ARROW PROCESSOR is presented with an ARROW, the ARROW PROCESSOR executes the instructions encoded in the ARROW until the execution is complete.

The terms ARROW, ARROW PROCESSOR and CENTAUR STORAGE as used herein and irrespective of case are trademarks of Centaur Storage, Inc. and where written herein shall be read as if followed by the appropriate designator: ARROW™, ARROW PROCESSOR™, and CENTAUR STORAGE™.

An embodiment of the present invention overcomes deficiency in the prior art by allowing a user to present an ARROW to an ARROW PROCESSOR, which then performs its operations in an automated manner, and presents the user with desired information. It therefore enables a computer program to handle (where handle includes and is not limited to sending, receiving, processing, or navigating) information of multiple web pages, services, or other data, with minimal or no additional user intervention.

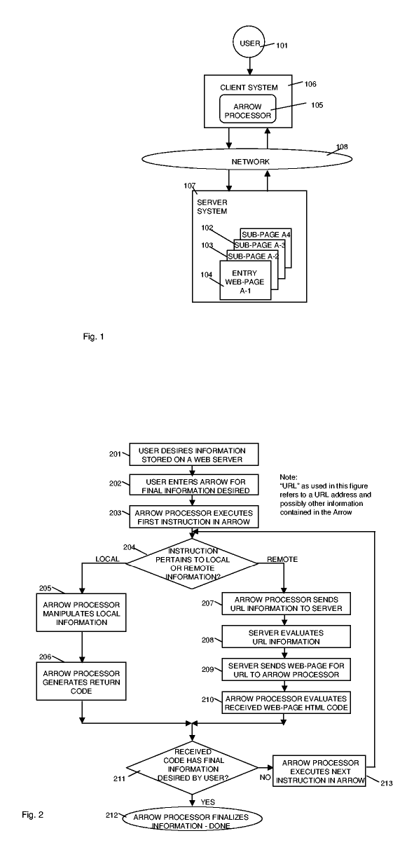

A block diagram of an embodiment is shown in FIG. 1. User 101 desires information that is contained in web page 102 (Sub-Page A-3), which may only be accessed via web page 103 (Sub-Page A-2). Web page 103 may only be accessed via web page 104 (Entry Web-Page A-1). For the purpose of this example, the user may have received an ARROW for web page 102 by email. The user 101 then requests web page 102 by presenting an ARROW into ARROW PROCESSOR 105 operating on client system 106, which is a computing device such as a workstation, laptop, or other portable media device. One method the user might use to initiate this transaction is to insert the ARROW at the client 106 by copying the email and pasting it to a graphical user interface of the ARROW PROCESSOR 105. The ARROW PROCESSOR then determines and executes the first instruction in the ARROW. In this example, the first instruction makes the ARROW PROCESSOR generate a request from the client system 106 for the entry page 104, perhaps supplying user information such as username and password. The request from the client system 106 is forwarded to the server system 107 via computer network 108, such as the Internet or a company intranet. Typically, the client, network, and server communicate using TCP/IP network protocols, although such protocols are exemplary and not required. Server system 107 processes the received URL, and returns the requested entry page 104, typically written in HTML. The ARROW PROCESSOR executes the second instruction in the arrow, and determines that the returned entry web page 104 does not have the final desired user information, so it generates a request to access web page 103, utilizing information contained in the HTML of web page 104. After the request is serviced, the ARROW PROCESSOR receives the information from web page 103. The ARROW PROCESSOR executes the third instruction in the ARROW, and again determines that the desired information has not yet been received, so the ARROW PROCESSOR generates a request to access web page 102, utilizing information contained in the HTML of web page 103. Once the ARROW PROCESSOR receives the information from web page 102, it examines the next ARROW instructions, which might contain instructions for the manner of presentation for the user. For example, if web page 102 represented a directory listing, the ARROW may describe a format for listing the directory by name, and to include details such as file size, creation date, etc.

In one aspect of the present invention, the ARROW is constructed in a manner that provides a useful result when presented to both an ARROW PROCESSOR and a traditional web browser that lacks an ARROW PROCESSOR. This construction makes the ARROW compatible with the existing base of web users and browsers utilizing existing protocols, such as hypertext transport protocol (http). In this embodiment, the ARROW might be represented by:
http://arrow.centaurstorage.com/LIUAyov7YjvRLbvljaMeGkG6tKrCiN8iHsTobzhmAPPgxHmjF d9afLIK1FVO7=MsjdJS8K2GTO=r39&DYulTvDiudmLSJyHiojwk.arw

When presented to the ARROW PROCESSOR by the user or other means, the ARROW PROCESSOR might typically begin by searching for 64-bit-encoded information. In the above example, the characters following the final slash “/” and before the termination “.arw” comprise this 64-bit encoded information. One embodiment of the information is serial blocks of bytes, where a block starts with an instruction (corresponding to a predetermined lookup table), and the remaining part of the block is supporting information for that instruction. An instruction block might represent an Internet web-page fetch, or a form fill-in with login and password, or a search for a link within a received web page. In another embodiment of the ARROW, the 64-bit-encoded information is scrambled to prevent observation of the set of instructions or the supporting information for the instructions. In yet another embodiment, the ARROW is encrypted and locked with a password that must be entered before execution can commence or continue. Such an embodiment might be implemented as a single instruction present in the ARROW that pops up a request for a password.

The ARROW can incorporate many types of instructions. Basic elements include iterative, conditional, and recursive instructions. More complex elements for web fetching, general searching, search-within-a-page, form fill-in, and file operations can also be included. An ARROW may contain instructions to fetch other ARROWs for execution by the ARROW PROCESSOR. This latter case allows for subscription services to ARROWs containing the latest information for navigation and processing of web information.

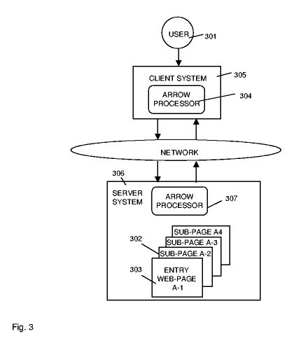

FIG. 2 provides a flow diagram for the steps required when a user retrieves information from a remote web server using the invention herein.

At step 201, the user identifies information that is stored on a remote web server and that he desires to view on his personal computer, such as a data-file that is contained in a directory within a password-protected account. At step 202, the user presents the ARROW for the user-desired information to the ARROW PROCESSOR on his computer. In this case, the contents of the specific data-file correspond to the final user-desired information, and the ARROW has an embedded instruction set and user login data for retrieving this data-file. At step 203, the ARROW PROCESSOR executes the first instruction in the ARROW and determines in step 204 whether this instruction is to be executed locally or remotely. If local, the ARROW PROCESSOR manipulates local information (e.g. generating identification credentials) in step 205, and then generates a return code in step 206. If the instruction in 204 is to be executed remotely, the ARROW PROCESSOR causes URL information for a web page (e.g. an account log-in page) to be sent to the server at step 207. (For the illustrative purpose of this example, “URL” is used here to refer to a URL address and possibly other information, such as username and password.) The server maps the URL to a web page at step 208. At step 209, the server sends the specified web page, typically HTML code, to the user's computer, for evaluation by the ARROW PROCESSOR at step 210. At step 211, the ARROW PROCESSOR determines whether the received HTML code contains the final user-desired information. If yes, the process is done, and the ARROW PROCESSOR finalizes (and possibly displays) the information at step 212. If no, the ARROW PROCESSOR executes the next instruction in the ARROW at step 213. Execution of the ARROW instruction may involve further evaluation of the returned information from steps 206 and 210. The process repeats until the ARROW PROCESSOR determines that the desired information has been obtained in step 211. No user interaction is required after the initial ARROW is entered. More extensive instruction sets, such as (but not limited to) accessing sub-directories or uploading user files to a remote account, searching for text or links, downloading from links, etc, may also be embedded in a single ARROW. Furthermore, instructions may be recursive, so that steps 205 or 210 may involve execution of other ARROWs in order to complete the step.

The previous example describes how the ARROW and ARROW PROCESSOR may be used to access a data-file on a remote server, as may be desired in a remote file-sharing application. Continuing the above file-sharing application example, the ARROW and ARROW PROCESSOR are advantageous for numerous other functions, including but not limited to simplifying account administration and security. In terms of account administration, a new user could be issued an ARROW that provides initial access to a remote-server account. Upon insertion of the ARROW into the ARROW PROCESSOR, the instructions in that ARROW may set up a mapped network drive on the recipient's computing device, perhaps by causing local machine code to be executed. In order to prevent others from utilizing the ARROW, the ARROW may include an instruction that allows only one-time execution of its instructions, perhaps by contacting and registering its use with a remote server. In this embodiment, ARROW instructions might be included to generate a set of machine-locked credentials to be transmitted to the mapped networked drive anytime access is desired. This process increases the security of the data stored by limiting its retrieval to only one physical computing device.

A block diagram of another embodiment is shown in FIG. 3. Similarly to a previous example, the user 301 desires information from web page 302, which can only be accessed from entry web page 303. The user presents an ARROW to his ARROW PROCESSOR 304 located on his system 305. In this case, the ARROW PROCESSOR 304 might recognize that web page 302 resides on a remote system 306 with its own ARROW PROCESSOR 307. Thus, the client's ARROW PROCESSOR might compile a second ARROW, with instructions to get information from web page 302, and may include other instructions, such as authorizing credentials for accessing the information.

In this manner, interaction of the ARROW and ARROW PROCESSOR is not limited to a local computing device. The ARROW PROCESSOR on the local computing device might communicate with remote ARROW PROCESSORs, perhaps relying on them to provide remote storage or additional computation power. Any number of services can therefore be set up and administered through an ARROW PROCESSOR network. An ARROW PROCESSOR network includes services such as but not limited to, enabling one computing device to upload a file to a server, and another computing device to begin downloading the same file while the upload is in process. One computing device issues a request to its local ARROW PROCESSOR to upload a file to a specified server. The local ARROW PROCESSOR compiles an ARROW to send to a remote ARROW PROCESSOR residing on the server, along with initial segments of the file to be uploaded. The remote ARROW PROCESSOR processes this ARROW (which could include machine-locked credentials in addition to the file segments) and compiles a return ARROW acknowledging receipt of the file segments. If a third computing device desires to download the file that is in the process of being uploaded, its local ARROW PROCESSOR sends an ARROW to the remote server ARROW PROCESSOR to download this file. The server ARROW PROCESSOR might determine that the file is in the process of being uploaded, and respond by sending an ARROW containing initial segments of the file along with instructions to wait for remaining file segments to be uploaded.

The previous examples describes how the ARROW and ARROW PROCESSOR may be used in a remote-file access and sharing application. The ARROW and ARROW PROCESSOR are advantageous for numerous other applications, including but not limited to, electronic commerce. For example, the invention would be beneficial for a user that frequently purchases flights on his favorite airline via the web. If utilizing a conventional web browser, the user may need to perform several steps prior to initiating the flight search, such as, (1) entering a URL to access the airline entry-level web page, (2) clicking on a link in the entry-level page to access an intermediate log-in page, (3) entering a user name and password, and clicking on a link to submit this information, (4) clicking on a link in another intermediate web page to select the user search method, such as Full-Flight-Search or Special Deals. Alternatively, an Arrow Processor may perform all of the above steps and the user need only enter a single Arrow that would contain information pertaining to the specific airline, account log-in, username, password, and preferred search method. Such an Arrow may be provided with the Arrow Processor program, or the program may enable users to create their own Arrows. For example, a user may create an Arrow by executing all steps required by a conventional web browser one time, in effect recording a macro for these steps, from which the Arrow is produced

An ARROW and ARROW PROCESSOR may also be used to perform Search Functions. Continuing the above example, a user may wish to compare multiple travel services (e.g. Expedia, Travelocity, etc.) to identify the cheapest rental car that meets his needs. The user may execute an Arrow that would contain an instruction to prompt the user to input information such as rental dates, times, and locations. This initial Arrow may also contain instructions to retrieve other secondary ARROWs from a server (say arrow.centaurstorage.com), for execution by the ARROW PROCESSOR. In this example, each of the secondary Arrows may contain instructions for retrieving information from a particular travel service. The initial ARROW may also contain an instruction for processing information returned by the other ARROWs, and an instruction for displaying this comparison information to the user via the ARROW PROCESSOR.

Another embodiment of the invention incorporates the ARROW PROCESSOR as an extension of the operating system, which allows local software to issue calls to the ARROW PROCESSOR to perform various functions. For example, the operating system may regard a collection of ARROWS as an extension of its own file system, so that items retrieved and sent by the ARROWS can be accessed or displayed by local software. Continuing the above illustrative embodiment, the ARROW ending in “.arw” signals the local operating system, Microsoft Windows for example, that the ARROW is meant for processing by a ARROW PROCESSOR program that has been registered. The operating system would dispatch the ARROW to the ARROW PROCESSOR, which would then search for the 64-bit encoded information and continue as in the above example.

In another illustrative embodiment, the ARROW and ARROW PROCESSOR may be used by financial institutions, such as the Bank of America, to securely exchange financial information with its clients. For example, a bank could send a client an ARROW to provide initial access to the private account on a remote server wherein the client may access banking information such as balances or monthly statements. The ARROW may be encoded for one-time use only, and the ARROW may generate a machine-locked set of login credentials that cause any future access to the account to be limited solely to the client's computer. Such an ARROW would be extremely difficult for a third party to reverse engineer in order to discover the client's login credentials. Further, because the login credentials generated using the ARROW lock to the client's specific computer, no third party may access the client's private directory from any other computer. Thus, the ARROW and ARROW PROCESSOR system offers substantially improved security over conventional banking web interfaces, which typically require only a username and password that can be discovered by a third party.

In another illustrative embodiment, the ARROW and ARROW PROCESSOR may be used to exchange documents across a research team, wherein team members reside on different computer networks. Documents may include (and are not limited to) data files, conference presentations, and journal articles. For example, a university professor may collaborate with an external industry partner, as well as with graduate students that may work inside or outside the professor's institution. In another example, industry colleagues from different companies or organizations may collaborate on a joint project. In such cases wherein remote team members reside on different computer networks and connect to the Internet through various firewalls, the ARROW and ARROW PROCESSOR provide a simple way to create a mapped drive on each member's computer for accessing a shared account on a remote server. Because the ARROW and ARROW PROCESSOR can be engineered to access the Internet through standard TCP web ports, port-blocking issues due to firewalls are avoided. For example, an ARROW having a header of the form http://arrow.centaurstorage.com accesses the Internet using TCP port 80, and an ARROW having a header of the form https://arrow.centaurstorage.com accesses the Internet using TCP port 443. In this manner, the ARROW and ARROW PROCESSOR enable easy, secure remote file sharing through the same ports utilized by conventional web browsers.

In another embodiment, the ARROW and ARROW PROCESSOR may be used by government or military personnel to quickly and securely exchange information between colleagues operating remotely. For example, an intelligence operative in a foreign country may connect his laptop to the Internet at a public cafe and access a private remote server account that is shared with an intelligence headquarters. In another example, battlefield data may be relayed and automatically updated utilizing the invention herein.

In another embodiment, the ARROW and ARROW PROCESSOR may be used by health institutions to handle a patient's medical records across multiple locations. For example, digitized xray films generated at a hospital facility may be uploaded to a private account on a remote server, and then accessed by a doctor on his office or home computer away from the facility. In another example, records of patient visits and associated data from those visits can be stored and retrieved using the invention presented herein.

In another embodiment, the ARROW and ARROW PROCESSOR may be used by firms in the legal profession to enable a group of partners to easily and securely exchange documents. For example, information pertaining to a legal case can be handled on a remote server for easy access from multiple offices or while traveling. The ARROW and ARROW PROCESSOR enable workgroup members to connect to a private on-line workspace from their home computers, office computers, or from their laptops when traveling.

More applications and approaches than are set forth here are apparent to those of skill in the relevant art. This invention is not intended to be limited to the examples set forth here but rather should be coextensive with the claims set forth and equivalents thereof and granted such scope as is afforded under all applicable laws.

What is claimed is:

1. A computing system for enabling a computer program to handle (where handle includes and is not limited to sending, receiving, processing, or navigating) information of multiple web pages comprising:
means for inserting a instruction set at the client;
means for processing the instruction set by utilizing a specialized processor, where the processor evaluates the information in order to decide which instruction to execute next without user intervention.

2. A system as in claim 1 wherein information may be local, may be on the web, or may be a combination of both.

3. A system as in claim 1 wherein the user inserts the instruction set.

4. A system as in claim 1 wherein the operating system inserts the instruction set.

5. A system as in claim 1 wherein an application program inserts the instruction set.

6. A system as in claim 1, wherein the instruction set navigates to a conventional URL when a specialized processor is not present.

7. A system as in claim 1, where the computer program activates off of a predetermined extension.

8. A system as in claim 1 wherein one or more computing devices contain a executable computer program to perform the functions in claim 1.

9. A system as in claim 1 wherein the instruction set is embedded in a web identifier, referred to herein as an ARROW.

10. A system as in claim 9 wherein the ARROW embeds an instruction set for executing a program flow.

11. A system as in claim 9 wherein the ARROW embeds an encryption of the instruction set, to prevent observation of instructions or navigation information.

12. A system as in claim 9 wherein the ARROW embeds a header, enabling integration into traditional browsers.

13. A system as in claim 9 wherein the ARROW embeds a trailer, enabling integration into operating systems.

14. A system as in claim 9 wherein the ARROW embeds instructions to set up a mapped network drive on a local computing device.

15. A system as in claim 9 wherein the ARROW embeds instructions to generate a set of machine-locked credentials to be transmitted.

16. A system as in claim 9 wherein the ARROW embeds an instruction that allows only one-time execution of its instructions.

17. A system as in claim 1 wherein the processor for processing the instruction set is a specialized browser, referred to herein as an ARROW PROCESSOR.

18. A system as in claim 17 wherein the ARROW PROCESSOR extracts instructions from the ARROW.

19. A system as in claim 17 wherein the ARROW PROCESSOR extracts non-instruction, supporting information from the ARROW.

20. A system as in claim 17 wherein the ARROW PROCESSOR executes a instruction set:
sending information to a remote or local machine;
receiving information from a remote or local machine;
executes next instruction, possibly using information contained in (a) &/or (b) to determine which next instruction to get;
repeats above steps to completion.

21. A system as in claim 17 wherein the ARROW PROCESSOR integrates (dispatching and/or receiving instructions) to a traditional browser.

22. A system as in claim 17 wherein the ARROW PROCESSOR integrates (dispatching and/or receiving instructions) to operating system.

23. A system as in claim 17 wherein the ARROW PROCESSOR displays graphically.

24. A system as in claim 17 wherein the ARROW PROCESSOR is used to handle information selected from the group consisting of: banking services, military services, intelligence-gathering services, universities and collaborators, medical services, and legal services.

25. A system as in claim 17 wherein one or more ARROW PROCESSORs on one or more local computing devices communicates with one or more ARROW PROCESSORs on one or more remote servers, forming an ARROW PROCESSOR network.

26. A system as in claim 24 wherein an ARROW PROCESSOR manages services among a plurality of computing devices, some of which may be equipped with their own ARROW PROCESSORs.

27. A system as in claim 24 wherein an ARROW PROCESSOR network enables one computing device to upload a file to a server, and another computing device to download the same file while the upload is in process.
